(19) United States
(12) Patent Application Publication
(10) Pub. No.: US 2003/0097949 A1
(43) Pub. Date: May 29, 2003

(54) Transfer printing process with edible inks

(76) Inventors: Andrew Candler, Morpeth (GB); John Russell, Bedlington (GB); James F. Woodhouse, Killingworth (GB); Angela Wright, Ashington (GB); Denise Metcalfe, Ashington (GB)

Correspondence Address: FISH & RICHARDSON P.C., 3300 DAIN RASCHER PLAZA, 60 SOUTH SIXTH STREET, MINNEAPOLIS, MN, 55402, US

(21) Appl. No.: 09/996,006

(22) Filed: Nov. 28, 2001

(51) Int. Cl. B41F 31/00

(52) U.S. Cl. 101/491

(57) ABSTRACT

A decorating kit including a transfer sheet having printed thereon a substantially non-tacky layer of an edible ink. The ink may be used in a transfer printing process for forming an image layer on a surface of an edible article. The transfer process includes providing a transfer sheet with a substantially non-tacky layer of an edible ink thereon; contacting the layer of edible ink with the surface of the edible article; and removing the transfer sheet such that the ink releases therefrom and forms an image layer on the surface of the edible article.

### TECHNICAL FIELD

The present invention relates to decorated food articles and methods for making them. More particularly, the invention relates to an edible ink composition, as well as a transfer printing process for making a decorated food article with the ink composition.

### BACKGROUND

Since early times cooks have decorated food articles to make them more appetizing and appealing to the consumer. For example, an exposed surface of a confection such as a cake, a cookie, or candy often includes multicolored edible decorations. To make these decorations, coloring agents may be sprayed or squirted by hand onto the surface of the confection. The time, difficulty and expense of the hand application process limits its use to small numbers of expensive bakery goods, and makes it impractical and/or impossible for the home cook to use hand decoration techniques on home-baked confections.

The mass-market appeal of movie, television, and sports has created a demand for confections and other food articles with multi-colored decorations bearing the likenesses of media figures. Bakeries, supermarkets and other food retailers have used increasingly sophisticated printing techniques to create these images on food articles.

For example, in a screen printing process, positive images are created from an artwork design. Using this positive image, printing screens are exposed and developed to include a negative image of the artwork design. A first color of an edible ink is then printed through the screen and onto a surface of a substrate, typically an icing layer or a sugar sheet, to form an image layer on the surface of the substrate. This step is repeated, one color at a time, until the multi-colored image is formed on the surface of the substrate. If the substrate is a sugar sheet, the surface of the sheet opposite the image layer may then be adhered to an icing on the food article. In a similar technique, a first color of an edible ink may be applied to a pad of an automatic pad transfer printer. The pad is then contacted with a hard, non-porous surface of an icing layer on a confection to form an image layer thereon. This step is repeated, one color at a time, until a multi-colored image layer is formed.

In the alternative, the artwork may be electronically scanned and the image file downloaded to an ink jet printer having a cartridge filled with at least one edible ink. The ink jet printer then applies the ink to a surface of a substrate, which may be a sugar sheet or an icing on a confection, to form an image layer thereon.

These techniques are much more efficient than a hand decorating process, and have made possible the creation of larger numbers of high-quality decorated food articles for purchase by a consumer. However, these techniques are relatively slow and unsuited for high volume production.

In addition, screen, pad transfer and ink jet printing techniques are complex and require a significant investment in printing equipment, so they are used principally by large volume bakeries and supermarkets, and are not useful for the home food decorator. The screen, pad transfer and ink jet printing techniques require careful control of the hardness and porosity of the printed surface to prevent running and smearing of the ink. Home decoration of confections is typically not conducted under such carefully controlled conditions, so the resulting images formed using these techniques would be expected to be of inconsistent quality.

In an attempt to make screen, pad transfer or ink jet printed substrates available to the home decorator, edible substrates may be prepared by screen or ink jet printing and sold to the consumer for application to a food article. However, the substrates, typically sugar sheets, are brittle and break easily during transit and handling by the consumer.

### SUMMARY

In one aspect, the invention is a decorating kit for use in transfer printing an icing on a surface of an edible article such as a cake, candy and the like. The decorating kit includes a transfer sheet having printed thereon a substantially non-tacky layer of an edible ink.

In a second aspect, the invention is an edible ink that is capable of being used in a transfer printing process. When a transfer sheet with a substantially non-tacky layer of the edible ink is contacted with an icing on an edible article, the ink softens, becomes flowable, releases from the transfer sheet and transfers to the surface of the icing to form an image layer thereon.

In a third aspect, the invention is a transfer printing process for forming an image layer on an icing on a surface of an edible article. In this process a transfer sheet with a substantially non-tacky layer of an edible ink is contacted with an icing on an edible article. The transfer sheet is then removed, and the edible ink transfers to the icing to form an image layer thereon.

In a fourth aspect, the invention is an edible article having thereon an image layer of the edible ink.

The transfer sheets of the invention provide a low cost technique for forming an image layer of an edible ink on an icing on a surface of an edible article. Since the edible ink layer on the transfer sheet is non-tacky, the image layer may be transferred with substantially less smearing and running than in conventional printing techniques. The image layer may be formed on a wide variety of icings, which makes the transfer technique convenient for a home decorating project.

The process of the invention also provides rapid transfer of the ink layer from the transfer sheet to form an image layer on an icing on the edible article. This rapid transfer allows a supermarket, bakery or other high volume shop to produce an increased number of imaged edible articles compared with conventional printing techniques.

The details of one or more embodiments of the invention are set forth in the description below. Other features, objects, and advantages of the invention will be apparent from the description, and from the claims.

### DETAILED DESCRIPTION

In a first aspect, the invention is a decorating kit for use in decorating an edible article. The transfer sheet includes a transfer sheet having applied on at least one surface thereof a layer of an edible ink.

The transfer sheet used in the home decorating kit may vary widely depending on the intended application, and any material suitable for contact with foods may be used. The materials used for the transfer sheet should be substantially free of leachable non-food grade chemicals that could potentially contaminate an edible article or the edible ink. Suitable materials for the transfer sheet include papers having thereon a coating of a plastic or a wax. Papers coated with polypropylene are preferred.

The edible inks of the invention may vary widely in composition depending on the characteristics of the surface of the transfer sheet, which typically has a dyne level of between about 20 and about 60, the characteristics of the surface of the edible article, the required drying time, and the like. The edible ink applied to the transfer sheet should be suitable for human consumption, and should preferably comply with applicable standards such as FD&C regulations in the United States and E.E.C. standards in the European Union.

At least one film former should be included in the edible ink of the invention at a concentration sufficient to allow the ink to “skin” rapidly. A preferred edible ink composition includes about 15% by weight to about 25% by weight, preferably about 20% by weight, of the film former. Preferred film formers include gums such as gum acacia, locust bean gum, guar gum, and methyl cellulose. Other suitable film formers include gelatins, carrageenan, pectin, purified shellacs, methocel and hydroxypropylmethylcellulose. Gum acacia is particularly preferred for printing on icings.

To further assist in rapid drying and film formation, the edible ink includes about 0.1% by weight to about 5% by weight, preferably less than about 1% by weight, and more preferably about 0.2% by weight, of a non-aqueous drying agent. Suitable examples include alcohols, such as ethanol and isopropanol.

The edible ink further includes about 0.5% by weight to about 10% by weight, preferably about 2% by weight to about 5% by weight of a humectant. Suitable humectants include glycerin, sorbitol, and mannitol.

The edible ink also includes about 5% by weight to about 15% by weight, preferably about 10% by weight to about 12% by weight, of an emulsifier, a stabilizer and/or a thickening agent. Suitable emulsifiers include lecithin, polyoxyethylene sorbitan monostearate, crillet, and crillet Veg A, sold under the trade designation TWEEN, and suitable stabilizers and/or thickeners include xanthan gum, sorbitol, and starches, such as maize starch, corn starch and potato starch.

The edible ink composition of the invention may further include about 0.1% by weight to about 5% by weight, preferably about 2% by weight, of a sweetener. Suitable sweeteners include sorbitol, glucose, dextrose, and aspartame. Sorbitol is particularly preferred.

The edible ink of the invention further includes about 2% by weight to about 50% by weight of a pigment. Any known pigment approved for human consumption may be used, including, for example, carmoisine, quinoline, ponceau 4R, blue 1, vegetable carbon, blue V, blue 2, titanium dioxide, and FD&C pigments such as yellow 5, red 3, red 40, blue 1, and blue 2.

The edible inks of the invention are typically dispersed in water and the resulting ink composition is applied to the transfer sheet to form at least one ink layer. The edible ink formulation adheres to the receptive image and forms an ink layer thereon. Multiple ink layers may be used to form an image, and these ink layers will be referred to herein for convenience as the ink layer. The edible ink formulation may be applied in any suitable printing apparatus or process. For example, printing processes that may be used include silk screen, wet offset, lithographic blanket transfer, flexographic Anolux roller transfer, letter press rotary relief plate, web print, reel to reel, and gravure. Suitable printing apparatus include dry offset printers available from Heidelberg Druckmaschinen AG, Heidelberg, Germany, A.B. Dick-Itek Limited, Middlesex, England and Sakurai Machinery, Koto-ku, Tokyo, Japan.

The ink layer, which typically is applied on the transfer sheet at a thickness of about 4 microns to about 6 microns, should be formulated so as to be capable of quickly forming a substantially non-tacky ink layer on the transfer sheet at room temperature in air. This prevents inadvertent running and/or smearing and facilitates the use of the ink composition in a high volume production process. The term substantially non-tacky as used herein refers to an ink layer that feels dry when touched. Substantially non-tacky ink layers can be achieved after the ink-bearing transfer sheet has been dried for about 5-15 minutes at room temperature (about 20° C. to about 22° C.) and at humidity levels of between about 50% and 55%. If necessary in a high volume application, heat may optionally be used to reduce drying time.

In the process of the invention, the transfer sheet is applied to a surface of an edible article such that the ink layer on the transfer sheet contacts a portion of the surface of the edible article. The surfaces on which the edible ink layer may be applied may vary widely, and may include any surface with sufficient strength and suitable surface characteristics to accept transfer of the ink layer. Examples include icings on confections such as cakes, cupcakes, muffins, doughnuts, cookies and the like, as well as chocolates and candy coatings.

When the ink layer is contacted with the surface of an edible article, the ink layer softens and becomes flowable, typically after about 20 seconds. Once the ink becomes flowable, the transfer sheet may be removed. As the transfer sheet is peeled away, the ink releases substantially completely from the transfer sheet and transfers to the surface of the edible article to form an image layer thereon. The transfer takes about 20 seconds when conducted at a temperature of between about 20° C. and about 22° C. and at humidity levels of between about 50% and about 55%. Under these conditions, the print is typically fully released from the transfer sheet.

To enhance transfer speed and efficiency, the surface of the edible article is generally moistened with any suitable wetting agent, such as, for example, water.

If the surface of the edible article is non-porous, once the transfer sheet is removed the ink layer dries to form a colorfast and brilliantly colored image layer on the surface. However, if the surface is porous, such as, for example, a cake icing, the flowable ink penetrates and is absorbed into the porous surface. Following this penetration step, at least a portion of the image layer lies beneath the surface. This provides an image layer that is particularly resistant to smearing and bleeding during the drying process. Once the transfer sheet is removed, the drying process generally is completed in about 5 to about 15 minutes when conducted at room temperature.

The printing process of the invention may be a part of any known process for making an edible article. Once an edible article is formed and baked or otherwise processed, a coating is applied to the article, such as an icing, chocolate, a hard coating or the like. An image layer may then be formed on a portion of an exposed surface of the coating using the process described above.

The invention will now be described with reference to the following non-limiting example.

### EXAMPLE

About 3 g of sorbitol, 3 g of maize starch, 20 g of gum acacia, and 62 g of water were placed in a stainless steel vessel and mixed for one minute with a hand held electric blender. About 1 g each of the following soluble pigments were added and blended until dissolved: quinoline for yellow, blue 1 for blue, and carmoisine for red. About 3 g of an insoluble black pigment, vegetable carbon, were added to the vessel and blended until dispersed. About 10 g of lecithin were added to the vessel and blended for 5 minutes. About 3 g of glycerine, 0.38 g of xanthan gum, and 0.3 g of propylene glycol were added and blended until dissolved. The entire mixture was then passed through a two tier jar mill at 25 rpm, and this step was repeated as necessary until a uniform dispersion was obtained. The resulting ink composition is shown in Table 1 below.

TABLE 1

| Component | Concentration (% by weight) |
|---|---|
| Water | 61.91-69.77 |
| Gum acacia | 19.70-23.0 |
| Lecithin | 0-11.25 |
| Sorbitol | 2.25-4.0 |
| Glycerine | 2.25-3.6 |
| Maize Starch | 2.11-3.0 |
| Xanthan Gum | 0.28-0.4 |
| Glycol | 0.22-0.3 |

The ink composition was sprayed on a 175 to 300 micron thick polypropylene coated transfer sheet. The ink dried to a substantially non-tacky finish at room temperature in about 10 minutes to form a 6 micron thick ink layer. The transfer sheet was applied to a cake having royal icing, such that the ink layer contacted the icing layer. Following a period of 20 seconds at room temperature, the transfer sheet was peeled away. The ink layer transferred completely to the icing to form an image layer thereon. The image layer dried in about 10 minutes to form a 4-color design.

A number of embodiments of the invention have been described. Nevertheless, it will be understood that various modifications may be made without departing from the spirit and scope of the invention. Accordingly, other embodiments are within the scope of the following claims.

What is claimed is:

1. A decorating kit comprising a transfer sheet having printed thereon a substantially non-tacky layer of an edible ink.

2. The decorating kit of claim 1, wherein the transfer sheet is selected from the group consisting of wax coated paper and plastic coated paper.

3. The decorating kit of claim 2, wherein the plastic coated paper is a polypropylene coated paper.

4. An edible ink comprising a film former, an emulsifier, a humectant and a drying agent.

5. The ink of claim 4, wherein the film former is selected from the group consisting of gums, methyl cellulose, gelatin, carrageenan, pectin, shellac, methocel and hydroxypropylmethylcellulose.

6. The ink of claim 4, wherein the emulsifier is selected from the group consisting of lecithin, polyoxyethylene, crillet, and crillet Veg A.

7. The ink of claim 4, wherein the humectant is selected from the group consisting of glycerin, sorbitol and mannitol.

8. The ink of claim 4, wherein the drying agent is selected from the group consisting of alcohols.

9. The ink of claim 4, further comprising a pigment.

10. An ink composition comprising water, a pigment, about 15% by weight to about 25% by weight of a film former, about 10% by weight to about 15% by weight of an emulsifier, about 0.5% by weight to about 5% by weight of a humectant, and less than about 1% by weight of a non-aqueous drying agent, with the total of 100% by weight.

11. The ink composition of claim 10, wherein the film former is selected from the group consisting of gum acacia, locust bean gum, guar gum, methyl cellulose, gelatin, carrageenan, pectin, shellac, methocel and hydroxypropylmethylcellulose.

12. The ink composition of claim 10, wherein the emulsifier is selected from the group consisting of lecithin, polyoxyethylene, crillet, and crillet Veg A.

13. The ink composition of claim 10, wherein the humectant is selected from the group consisting of glycerin, sorbitol and mannitol.

14. The ink composition of claim 10, wherein the drying agent is selected from the group consisting of alcohols and propylene glycol.

15. A transfer printing process for forming an image layer on a surface of an edible article, comprising:
(a) providing a transfer sheet with a substantially non-tacky layer of an edible ink thereon;
(b) contacting the layer of edible ink with the surface of the edible article; and
(c) removing the transfer sheet such that the ink releases therefrom and forms an image layer on the surface of the edible article.

16. The transfer printing process of claim 15, wherein the edible ink comprises a pigment, about 15% by weight to about 25% by weight of a film former, about 10% by weight to about 15% by weight of an emulsifier, about 0.5% by weight to about 5% by weight of a humectant, and less than about 1% by weight of a non-aqueous drying agent, with the total of 100% by weight.

17. The transfer printing process of claim 15, further comprising the step of applying a wetting agent to the surface of the edible article prior to step (b).

18. The transfer printing process of claim 15, wherein a portion of the image layer lies beneath the surface of the edible article.

19. The transfer printing process of claim 15, further comprising drying the image layer.

20. An edible article comprising an image layer on a surface, wherein the image layer is applied with the transfer printing process of claim 15.

21. A decorating kit comprising a transfer sheet having printed thereon a substantially non-tacky layer of an edible ink, wherein the ink is capable of releasing from the transfer sheet and forming an image layer on a surface of an edible article.

22. The decorating kit of claim 21, wherein the edible ink comprises a pigment, about 20% by weight of a film former, about 12% by weight of an emulsifier, about 2% by weight of a humectant, and less than about 1% by weight of a non-aqueous drying agent, with the total of 100% by weight.

23. The decorating kit of claim 22, wherein the ink comprises about 0.2% by weight of the drying agent.

24. A process for making a decorated edible article, comprising:
(a) providing an edible article;
(b) applying a coating to a surface of the edible article;
(c) contacting the coating with a substantially non-tacky ink layer on a transfer sheet; and
(d) removing the transfer sheet such that the ink releases therefrom and forms an image layer on the coating.
